(19) United States
(12) Patent Application Publication
(10) Pub. No.: US 2010/0235537 A1
(43) Pub. Date: Sep. 16, 2010

(54) Information Processing Device and Method, Program, and Information Processing System

(76) Inventor: Naohisa KITAZATO, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/717,630

(22) Filed: Mar. 4, 2010

(30) Foreign Application Priority Data
Mar. 13, 2009 (JP) P2009-061152

(51) Int. Cl. G06F 15/16

(52) U.S. Cl. 709/233

(57) ABSTRACT

An information processing device includes a broadcasting apparatus broadcasting a content at a predetermined transmission rate to at least a receiver downloading the content and a generating unit generating metadata for the content. The metadata contains download-rate state information indicating a state of the predetermined transmission rate with respect to a reproduction rate at the receiver. The broadcasting apparatus further broadcasts the metadata generated by the generating unit.

### BACKGROUND OF THE INVENTION

1. Field of the Invention

The present invention relates to information processing devices and methods, programs, and an information processing system, and in particular to information processing devices and methods, programs, and an information processing system that can perform progressive reproduction in an appropriate manner in download broadcasting.

2. Description of the Related Art

Along with widespread use of the Internet and other high-speed data communication networks, there have been content downloading services that commercialize various contents including music pieces, movies, and computer programs (see Japanese Unexamined Patent Application Publication No. 2000-113066, for example).

In content downloading services in the past, a receiver is connected to a predetermined server via the Internet, acquires contents from this server, accumulates these contents, and uses (views) the accumulated contents at any time.

In recent years, as television broadcasting is digitized, the amount of information that can be simultaneously broadcast dramatically increases and accordingly various data can be broadcast at the same time, in addition to common television programs that are viewable in real time. It is proposed, therefore, that television broadcasting be utilized for content downloading services.

More specifically, there is proposed a content downloading service that enables a receiver to receive and accumulate the contents broadcast by television broadcasting, and use (view) the accumulated contents at any time. Such a downloading service will be referred to below as download broadcasting.

### SUMMARY OF THE INVENTION

In download broadcasting, however, the demand for progressive reproduction at the receiving side is not fully satisfied. The term “progressive reproduction” refers to a process of progressively reproducing a predetermined content that is being downloaded, i.e., before having been fully downloaded.

It is desirable to enable progressive reproduction in an appropriate manner in download broadcasting.

A first information processing device according to an embodiment of the present invention includes a broadcasting means for broadcasting a content at a predetermined transmission rate to at least a receiver downloading the content, and a generating means for generating metadata for the content, the metadata containing download-rate state information indicating a state of the predetermined transmission rate with respect to a reproduction rate at the receiver. The broadcasting means further broadcasts the metadata generated by the generating means.

The metadata further contains information indicating a delay time before the receiver can start progressive reproduction of the content being downloaded after downloading of the content is started.

The download-rate state information includes information indicating whether or not a mode in which the broadcasting means broadcasts the content at the predetermined transmission rate is an equal-speed download mode in which the predetermined transmission rate is synchronized with the reproduction rate at the same rate.

The download-rate state information further includes information indicating that the mode is one of a low-speed download mode in which the amount of information of the content being downloaded that has been downloaded over any time length since its downloading was started is in some cases less than the amount of information of the content that has been reproduced over the same time length since its reproduction was started, a high-speed download mode in which the amount of information of the content being downloaded that has been downloaded over any time length since its downloading was started is more than the amount of information of the content that has been reproduced over the same time length since its reproduction was started, the equal-speed download mode described above, and an undefined mode in which the relationship between the predetermined transmission rate and the reproduction rate is unknown.

A first information processing method and a first program according to an embodiment of the invention are the method and program for the first information processing device according to the embodiment described earlier.

In the first information processing device and method and first program according to the embodiment, a content is broadcast at a predetermined transmission rate to at least a receiver downloading the content. Metadata for the content is generated and broadcast, which contains download-rate state information indicating a state of the transmission rate with respect to the reproduction rate at the receiver.

A second information processing device according to another embodiment of the invention includes a receiving means for receiving a download content when the content is broadcast at a predetermined transmission rate from a broadcasting apparatus, and receiving metadata for the content when the metadata is broadcast from the broadcasting apparatus or sent from an external device, the metadata containing download-rate state information indicating a state of the predetermined transmission rate with respect to a reproduction rate, and a reproduction control means for controlling, according to the metadata received by the receiving means, progressive reproduction of the content at the reproduction rate while the receiving means is receiving the content.

The metadata further contains information indicating a delay time before the progressive reproduction can be started after downloading of the content is started. The reproduction control means starts the progressive reproduction at an optional time when the delay time has elapsed after the receiving means started receiving the content.

The download-rate state information includes information indicating whether or not a mode in which the broadcasting means broadcasts the content at the predetermined transmission rate is an equal-speed download mode in which the predetermined transmission rate is synchronized with the reproduction rate at the same rate. The reproduction control means determines, based on the download-rate state information contained in the metadata received by the receiving means, the time at which the progressive reproduction can be started.

The download-rate state information further includes information indicating that the mode is one of a low-speed download mode in which the amount of information of the content being downloaded that has been downloaded over any time length since its downloading was started is in some cases less than the amount of information of the content that has been reproduced over the same time length since its reproduction was started, a high-speed download mode in which the amount of information of the content being downloaded that has been downloaded over any time length since its downloading was started is more than the amount of information of the content that has been reproduced over the same time length since its reproduction was started, the equal-speed download mode, and an undefined mode in which the relationship between the predetermined transmission rate and the reproduction rate is unknown.

If the download-rate state information contained in the metadata received by the receiving means is information indicating the equal-speed downloading, the reproduction control means further controls notification to the user, together with notification of the broadcast start time of the content, that the content is a real-time reproducible content.

After controlling the notification to the user, the reproduction control means further controls reception of user operations for progressive reproduction of the content after broadcasting of the content is started, and then caches the content received by the receiving means and controls reproduction of the content at the reproduction rate synchronous with the transmission rate when an instruction is given by the user to start reproduction.

The reproduction control means further controls notification to the user of the reproduction-startable time at which the progressive reproduction can be started.

The reproduction control means further controls, after the reproduction-startable time, reception of user operations for progressive reproduction of the content.

A second information processing method and a second program according to an embodiment of the invention are the method and program for the second information processing device according to the embodiment described earlier.

In the second information processing device and method and second program according to the embodiment, when a download content is broadcast at a predetermined transmission rate from a broadcasting apparatus and metadata for the content, which contains download-rate state information indicating a state of the predetermined transmission rate with respect to a reproduction rate, is broadcast from the broadcasting apparatus or sent from an external device, the content and metadata are received. Progressive reproduction of the content is controlled using the received metadata to reproduce the content at the reproduction rate while the content is being received.

An information processing system according to an embodiment of the invention includes a first information processing device corresponding to the first information processing device according to the embodiment described earlier and a second information processing device corresponding to the second information processing device according to the other embodiment described earlier.

In the information processing system according to the embodiment, the first information processing device broadcasts a content at a predetermined transmission rate to at least a receiver downloading the content, and generates and broadcasts metadata containing download-rate state information indicating a state of the transmission rate with respect to a reproduction rate at the receiver. The second information processing device receives the metadata sent from the first information processing device, and uses the received metadata to control progressive reproduction of the content to reproduce the content at the reproduction rate while the content is being received.

As described above, the embodiments of the present invention enable progressive reproduction appropriately in download broadcasting.

### BRIEF DESCRIPTION OF THE DRAWINGS

FIG. 1 shows an exemplary configuration of a content downloading system in an information processing system according to an embodiment of the invention;

FIG. 2 illustrates sending and receiving flows for download broadcasting;

FIG. 3 is a block diagram showing an exemplary configuration of a receiver with storage for download broadcasting;

FIG. 4 shows an exemplary signal configuration for download broadcasting;

FIG. 5 shows an exemplary metadata configuration for download broadcasting;

FIG. 6 shows an exemplary signal hierarchy for download broadcasting;

FIGS. 7A and 7B show an example of normal operation of a receiver with storage in download broadcasting;

FIG. 8 shows an exemplary screen transition at the receiving side in download broadcasting;

FIGS. 9A and 9B show an example of progressive reproduction operation by a receiver with storage in download broadcasting;

FIG. 10 illustrates a progressive reproduction start time in high-speed downloading;

FIG. 11 illustrates a progressive reproduction start time in low-speed downloading at a fixed broadcast transmission rate;

FIG. 12 illustrates a progressive reproduction start time in low-speed downloading at a variable broadcast transmission rate;

FIG. 13 illustrates a progressive reproduction start time in equal-speed downloading;

FIG. 14 illustrates sending and receiving flows in equal-speed download broadcasting;

FIG. 15 is a block diagram showing an exemplary configuration of a receiver without storage for download broadcasting;

FIG. 16 shows an exemplary metadata configuration for download broadcasting according to an embodiment of the invention;

FIG. 17 shows an exemplary XML notation of progressive DL information contained in the metadata in FIG. 16;

FIG. 18 shows an exemplary binary notation of the progressive DL information contained in the metadata in FIG. 16;

FIG. 19 shows an exemplary program list for progressive reproduction displayed on a screen;

FIG. 20 is a flowchart illustrating an example of metadata receiving processing performed by a receiver with storage;

FIG. 21 is a flowchart illustrating an example of metadata receiving processing performed by a receiver without storage; and

FIG. 22 is a block diagram showing an exemplary hardware configuration of the information processing device according to an embodiment of the invention.

### DESCRIPTION OF THE PREFERRED EMBODIMENTS

### [Overview of Download Broadcasting]

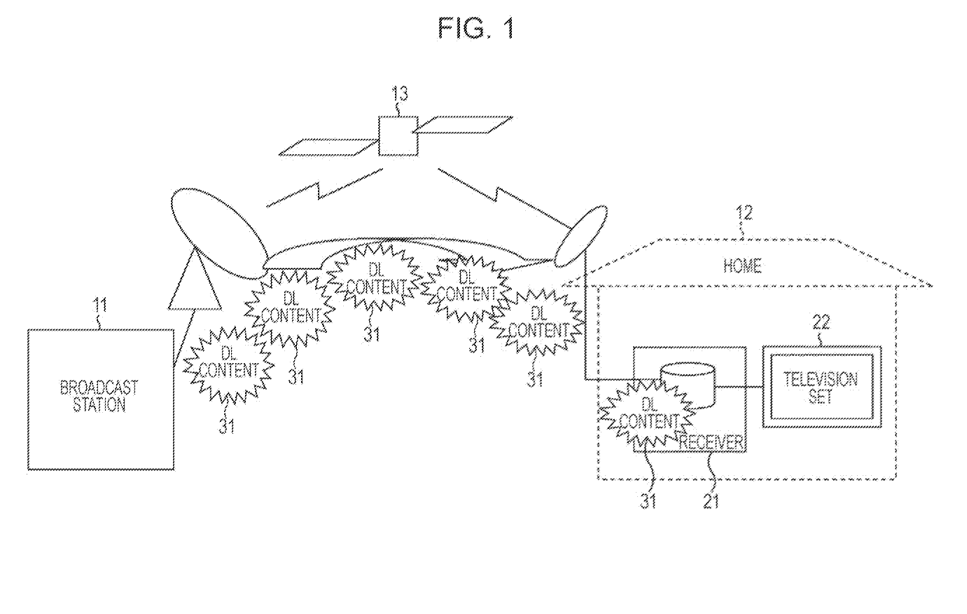

FIG. 1 shows an exemplary configuration of a content downloading system in an information processing system according to an embodiment of the invention.

In the example in FIG. 1, the content downloading system is compatible with download broadcasting. The content downloading system includes a broadcast station 11, as well as a receiver 21 and a television set 22 installed at a user's home 12.

The broadcast station 11 broadcasts a download content 31 (referred to below as a DL content 31) using a television broadcast signal via a satellite 13.

In the example in FIG. 1, the broadcast station 11 uses a satellite broadcast wave for television broadcasting. The television broadcasting technique used by the broadcast station 11 is not limited to that in the example in FIG. 1, but other techniques using a ground wave or through a CATV (community antenna television, cable television) network may be employed. In addition, techniques using other broadcast wave than the television broadcast wave, such as digital radio broadcast wave, for example, may be employed.

The receiver 21 can receive (acquire) and accumulate DL contents 31. The process of receiving (acquiring) and accumulating DL contents 31 is referred to below as downloading DL contents 31. The receiver 21 can also reproduce the DL content 31 in a television set 22 or the like at any time during its availability period.

The receiver 21 may be installed inside the television set 22, although it is installed outside the television set 22 in the example in FIG. 1.

### [Sending and Receiving Flows for Download Broadcasting]

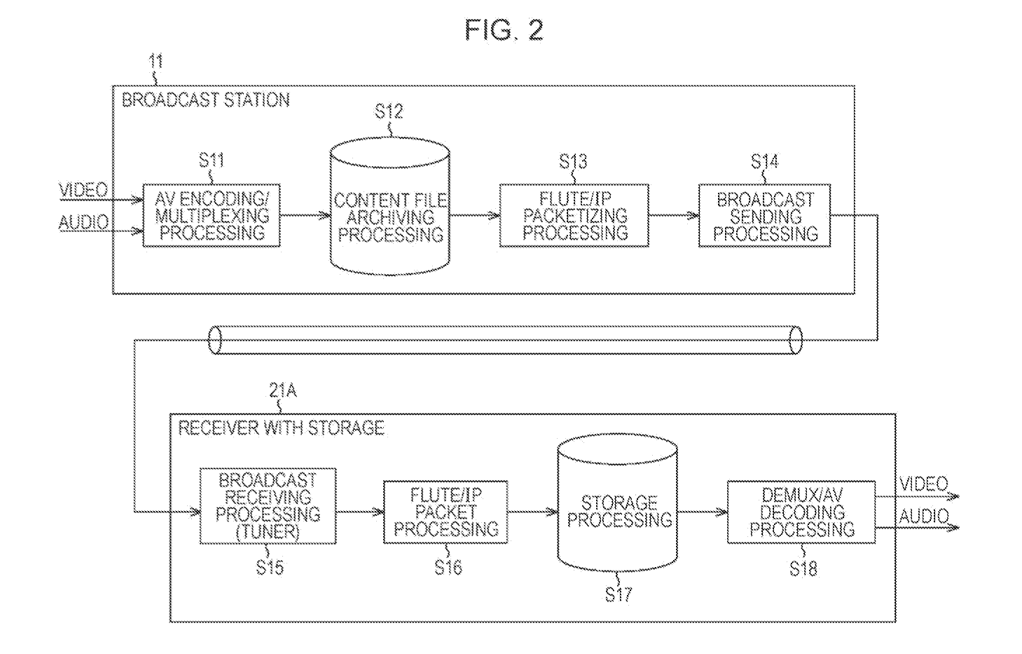

FIG. 2 illustrates sending and receiving flows for download broadcasting.

When video and audio signals forming a DL content 31 are supplied, the broadcast station 11 performs AV encoding/multiplexing processing in step S11. The AV encoding/multiplexing processing refers to a process of generating a file of the DL content 31 by compress-encoding the video and audio signals in a predetermined scheme and multiplexing the resultant video and audio data. This file is referred to below as a content file. The content file is not limited to any unit, although it contains a single program in the present embodiment. More specifically, in the present embodiment, one content file contains a DL content 31 forming a single program. A program formed as the DL content 31 is referred to below as a download program.

In step S12, the broadcast station 11 retains content files. This processing in step S12 is referred to below as content file archiving processing. The broadcast station 11 also retains various information (referred to below as metadata) about the download program.

According to a predetermined broadcast schedule, the broadcast station 11 performs FLUTE/IP packetizing processing in step S13 and performs broadcast sending processing in step S14. The FLUTE/IP packetizing processing refers to a process of packetizing the content file and other information into a transport stream (TS) according to the file delivery over unidirectional transport (FLUTE) protocol or user datagram protocol (UDP)/internet protocol (IP). The broadcast sending processing includes a series of processing steps for sending TS packets over broadcast waves.

The above flow from step S11 to step S14 is the sending flow at the broadcast station 11 for download broadcasting.

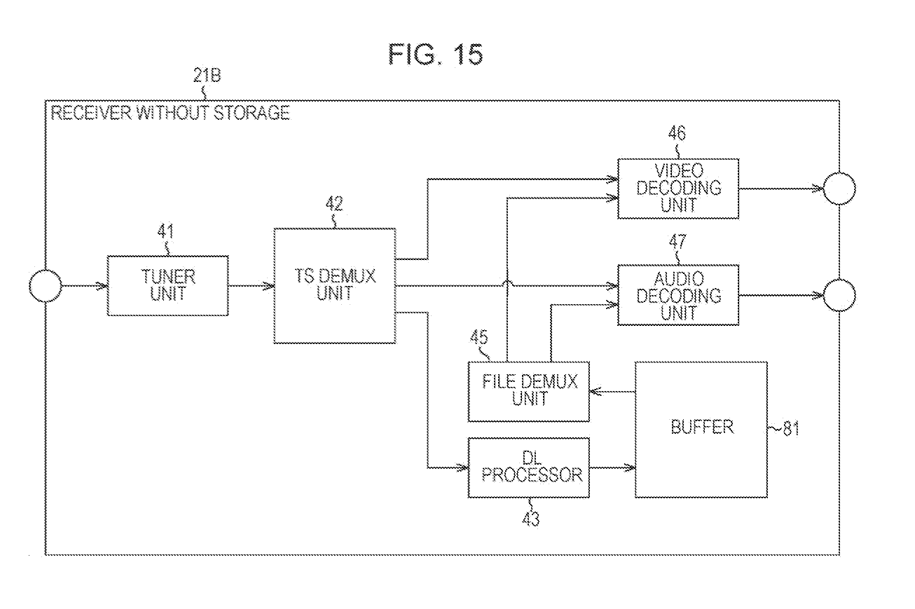

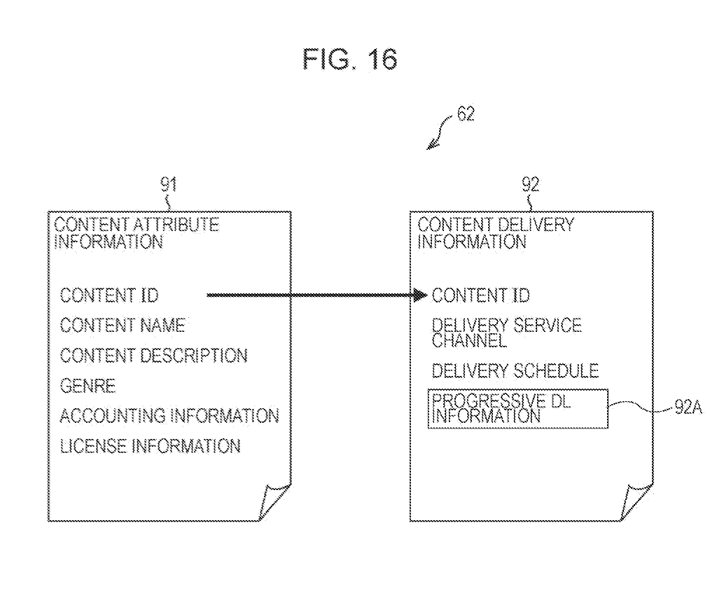

The following flow from step S15 to step S18 is the receiving flow at a receiver with storage 21A for download broadcasting. It should be noted that a storage-equipped version of the receiver 21 is referred to below as the receiver with storage 21A, because there is also a receiver without storage 21B as shown in FIGS. 15 and 16 and described below.

The receiver with storage 21A performs broadcast receiving processing in step S15, FLUTE/IP packet processing in step S16, and storage processing in step S17.

The broadcast receiving processing includes a series of processing steps from the reception by a tuner of the broadcast wave to the extraction of the TS packets from the received signal. The FLUTE/IP packet processing refers to a process of restoring the content file and other information from the TS packets according to the FLUTE protocol or UDP/IP. The storage processing refers to a process of accumulating the content file and other information in a storage.

In this manner, each download program (DL content 31) is downloaded by the processing in steps S15 to S17.

In step S18, the receiver with storage 21A performs demux/AV decoding processing of the content file at any time during its availability period. The demux/AV decoding processing includes a series of processing steps of separating video data and audio data contained in the content file to be reproduced, expand-decoding these data in respective predetermined schemes, and outputting the resultant video and audio signals.

These video and audio signals are supplied to the television set 22, for example, where the download program (DL content 31) is reproduced.

[Exemplary Configuration of Receiver with Storage 21A]

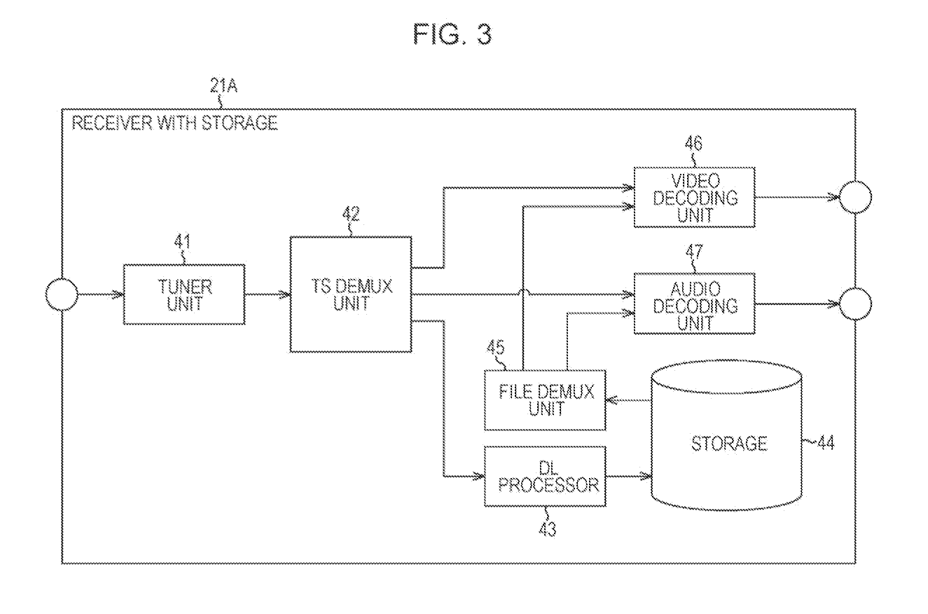

FIG. 3 shows an exemplary configuration of the receiver with storage 21A.

The receiver with storage 21A includes a tuner unit 41, TS demux unit 42, DL processor 43, storage 44, file demux unit 45, video decoding unit 46, and audio decoding unit 47.

The tuner unit 41 receives a satellite broadcast wave sent from the broadcast station 11 via the satellite 13 and supplies the received signal to the TS demux unit 42. The TS demux unit 42 extracts TS packets from the signal received by the tuner unit 41. The TS packets are supplied to the DL processor 43. In this manner, the tuner unit 41 and the TS demux unit 42 perform the broadcast receiving processing in step S15 in FIG. 2.

The receiver with storage 21A is compatible with not only the download broadcasting but also what is termed real-time broadcasting. For real-time broadcasting, audio stream data is generated from the audio packets among the TS packets and supplied to the audio decoding unit 47, while video stream data is generated from the video packets among the TS packets and supplied to the video decoding unit 46.

The DL processor 43 restores the content file and other information from the TS packets according to the FLUTE protocol or UDP/IP and accumulates the restored content file and other information in the storage 44. A plurality of download programs (DL contents 31) are thus accumulated in the form of content files in the storage 44. The metadata is also accumulated in the form of files. In this manner, the DL processor 43 performs the FLUTE/IP packet processing in step S16 and the storage processing in step S17.

The file demux unit 45 searches the content files accumulated in the storage 44 for the content file to be reproduced and separately acquires the video data and audio data contained in this content file. The video data is supplied to the video decoding unit 46, while the audio data is supplied to the audio decoding unit 47.

The video decoding unit 46 expand-decodes the video data in a predetermined scheme and outputs the resultant video signal. The audio decoding unit 47 expand-decodes the audio data in a predetermined scheme and outputs the resultant audio signal.

In this manner, the file demux unit 45, video decoding unit 46, and audio decoding unit 47 perform the demux/AV decoding in step S18 in FIG. 2.

### [Signal for Download Broadcasting]

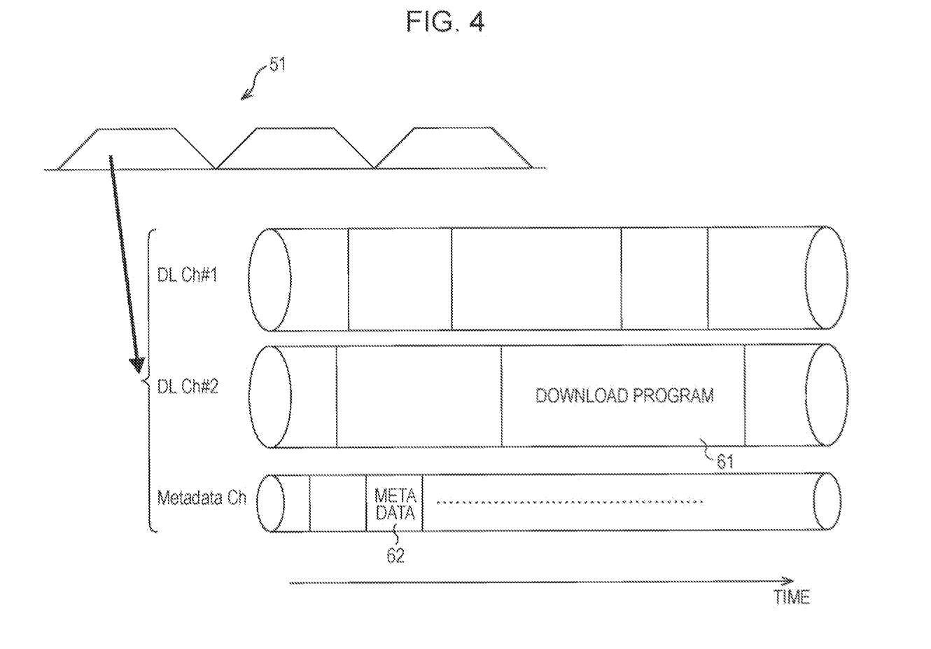

FIG. 4 shows an exemplary signal configuration for download broadcasting.

As shown in FIG. 4, the download broadcast signal 51 is a set of signals in respective channels. More specifically, in the example in FIG. 4, the download broadcast signal 51 includes signals DL Ch #1, DL Ch #2, and Metadata Ch. The signal DL Ch #1 contains the download programs 61 to be broadcast in the channel 1, allocated to respective broadcast time frames. The signal DL Ch #2 contains the download programs 61 to be broadcast in the channel 2, allocated to respective broadcast time frames. The signal Metadata Ch contains a plurality of metadata 62.

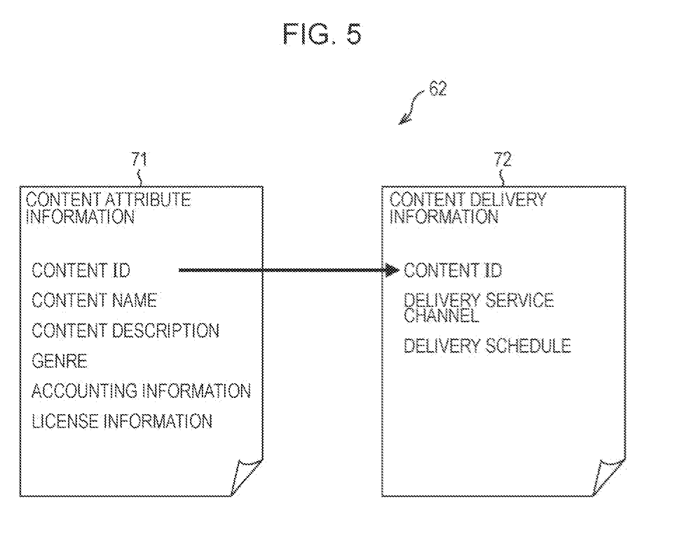

The metadata 62 contains various information pieces about the download programs 61 in the channel 1 or 2. The metadata 62 has the configuration shown in FIG. 5, for example.

FIG. 5 shows an exemplary configuration of the metadata 62 for download broadcasting.

As shown in FIG. 5, the metadata 62 is broadly divided into content attribute information 71 and content delivery information 72.

The content attribute information 71 mainly contains information to be presented to the user. For example, the content attribute information 71 contains a content name, content description, genre, accounting information, and license information.

The content delivery information 72 mainly contains content control information. For example, the content delivery information 72 contains a content ID, delivery service channel, and delivery schedule.

The content ID is included in both the content attribute information 71 and the content delivery information 72. The content attribute information 71 and the content delivery information 72 sharing the same content ID form the metadata 62 for the DL content 31 (one predetermined download program in the present embodiment) identified by this content ID. In other words, the content attribute information 71 and the content delivery information 72 are associated with each other by the content ID.

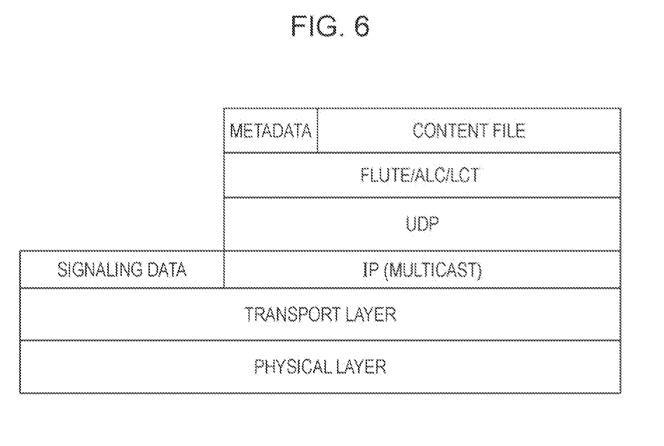

FIG. 6 shows an exemplary signal hierarchy for download broadcasting.

As shown in FIG. 6, a physical layer is located in the lowermost layer and a transport layer is located above the physical layer. Above the transport layer, there are signaling data as a control signal, as well as IP (multicast). UDP is located above the IP (multicast) and FLUTE/ALC/LCT is located above the UDP. Metadata as the metadata 62 and the content file containing the download program 61 are located in the uppermost layer.

### [Example of Normal Operation at the Receiving Side for Download Broadcasting]

Next, an example of receiving-side operation for download broadcasting will be described.

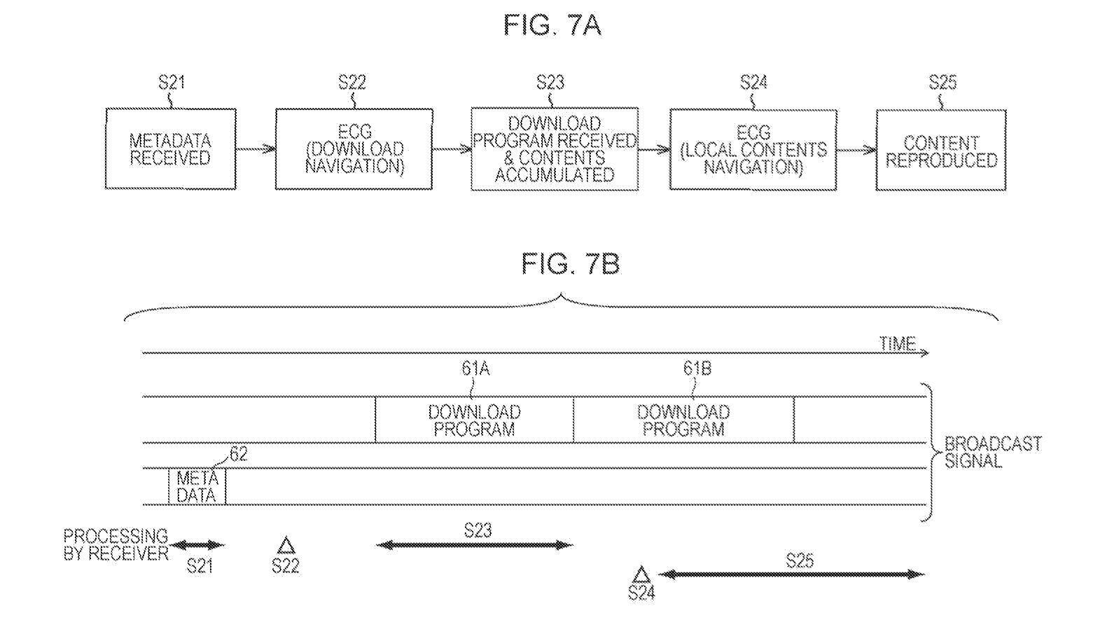

FIGS. 7A and 7B show an example of normal operation of the receiver with storage 21A for download broadcasting.

FIG. 7A shows a horizontal flowchart and FIG. 7B shows a broadcast signal timing chart. The processing timing of each step shown in the flowchart in FIG. 7A is shown to the right of PROCESSING BY RECEIVER in FIG. 7B.

The receiver with storage 21A receives metadata 62 in step S21. As described above with reference to FIG. 4, the metadata 62 is transmitted by the download broadcast signal. In step S21, the processing steps S15 to S17 in FIG. 2 are performed and the metadata 62 is accumulated in the storage 44 in FIG. 3.

When the user then operates the receiver with storage 21A to obtain information about the future schedule of download broadcasting, for example, the ECG (electronics contents guide) (download navigation) processing is performed in step S22.

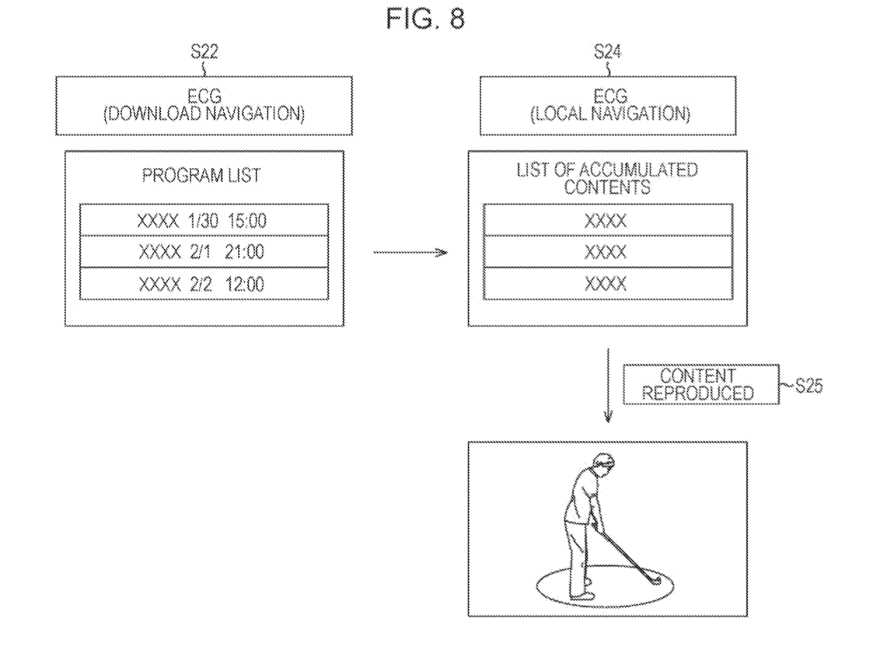

The ECG (download navigation) processing refers to a process of displaying on the screen a program list as shown in the upper left in FIG. 8. The program list includes various information (for example, program names and broadcast start times) about the download programs to be broadcast according to the broadcast schedule of the broadcast station 11.

FIG. 8 shows an exemplary screen transition at the receiving side for download broadcasting.

The user can select download programs from the programs listed on the screen by operating the receiver with storage 21A. The receiver with storage 21A can download all or some of the programs to be broadcast from the broadcast station 11.

Suppose here that only the download program 61A, for example, is selected from the download programs 61A and 61B.

In this case, in step S23, the receiver with storage 21A receives the download program 61A during the broadcast time frame allocated for the download program 61A and accumulates the download program 61A in the form of a content file in the storage 44. In this manner, in step S23, the processing steps S15 to S17 in FIG. 2 are performed and the content file (DL content 31) of the download program 61A is accumulated in the storage 44.

When the user then operates the receiver 21 to reproduce a desired program among the programs (DL contents 31) that have been downloaded, the ECG (local contents navigation) processing is performed in step S24.

The ECG (local contents navigation) processing refers to a process of displaying on the screen a list of various information (for example, program names) of the programs that have been downloaded and accumulated in the storage 44, as shown in the upper right in FIG. 8.

The user can select the program to be reproduced from this list of accumulated contents by operating the receiver with storage 21A. Suppose here that the download program 61A is selected for reproduction.

In this case, in step S25, the receiver with storage 21A reproduces the download program 61A (DL content 31). More specifically, in step S25, the processing step S18 described with reference to FIG. 2 is performed and the download program 61A is reproduced as shown in the lower right in FIG. 8.

The exemplary normal operation of the receiver with storage 21A for download broadcasting has been described.

### [Example of Progressive Reproduction at the Receiving Side in Download Broadcasting]

Next, an example of progressive reproduction operation at the receiver with storage 21A in download broadcasting will be described.

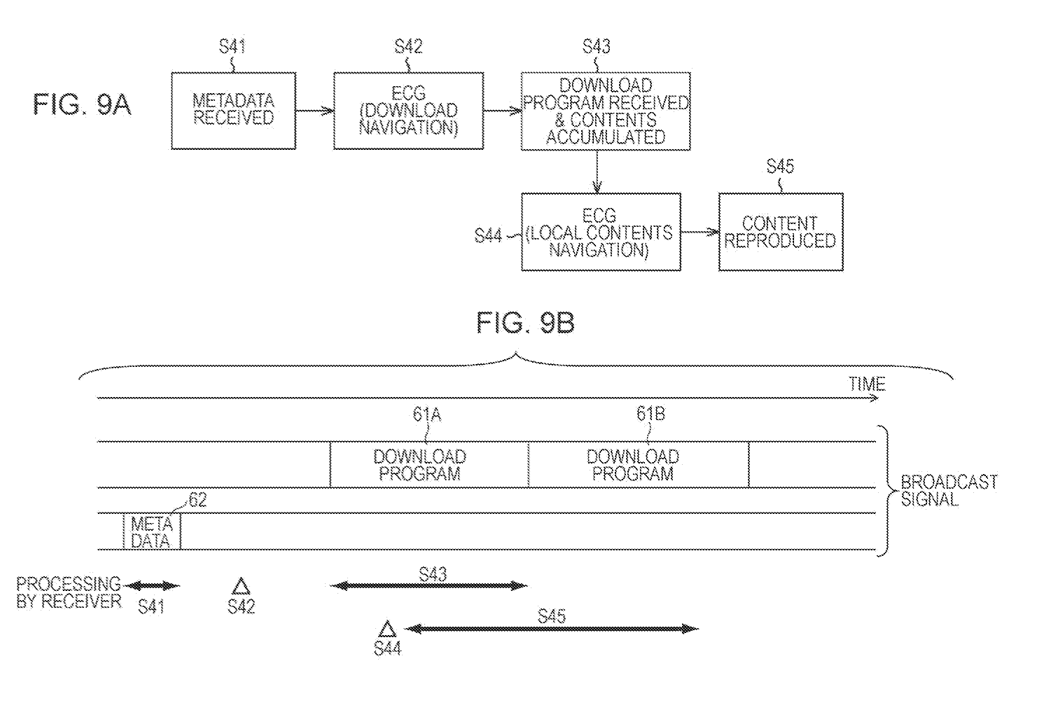

FIGS. 9A and 9B show an example of progressive reproduction operation by the receiver with storage 21A in download broadcasting.

FIG. 9A shows a horizontal flowchart and FIG. 9B shows a broadcast signal timing chart. The processing timing of each step shown in the flowchart in FIG. 9A is shown to the right of PROCESSING BY RECEIVER in FIG. 9B.

The processing steps S41 to S43 are the same as the processing steps S21 to S23 in FIGS. 7A and 7B, so description thereof will be omitted.

Suppose here that the user operates the receiver with storage 21A to display a list of accumulated contents while the processing in step S43 is in progress, i.e., while the download program 61A is being downloaded. Then, the ECG (local contents navigation) processing is performed in step S44 and a list of accumulated contents such as the one shown in the upper right in FIG. 8 is displayed on the screen.

The user can select the program to be reproduced from the list of accumulated contents by operating the receiver with storage 21A. Suppose here that the download program 61A is selected for reproduction.

Then, in step S45, the receiver with storage 21A reproduces the download program 61A (DL content 31). The download program 61A is progressively reproduced as shown in the lower right in FIG. 8 while being downloaded.

Such progressive reproduction will fail if the portion being reproduced passes the portion being downloaded. It is difficult to start reproduction of the program being downloaded at any time after its downloading is started. The time at which its reproduction can be started without reproduction failure halfway through depends on the relationship between the download speed (transmission rate of DL content 31) and the reproduction speed (reproduction rate of DL content 31).

In the field of download delivery by communication, downloading usually progresses in a best effort manner. It is difficult, therefore, to predict a reproduction-startable time that does not cause reproduction failure halfway through.

On the contrary, in the field of broadcast downloading, the progress of change in the transmission rate of the broadcast DL content 31 (referred to below as a broadcast transmission rate) is predictable, irrespective of the transmission rate being fixed or variable. The reproduction-startable time is easily predictable to prevent reproduction from failing halfway through.

### [Progressive Reproduction-Startable Time in Broadcast Downloading]

The progressive reproduction-startable time in broadcast downloading will be further described below.

In broadcast downloading, two types of download operations are expected: downloading at a rate higher than the actual reproduction rate and downloading at a rate lower than the actual reproduction rate. The former broadcast downloading performed at a broadcast transmission rate higher than the reproduction rate will be referred to below as high-speed downloading. The latter broadcast downloading performed at a broadcast transmission rate lower than the reproduction rate will be referred to below as low-speed downloading. These definitions in this paragraph are, however, provisional and intended to simplify the description below. Formal definitions will be given later in the description of the metadata 62 according to an embodiment of the invention.

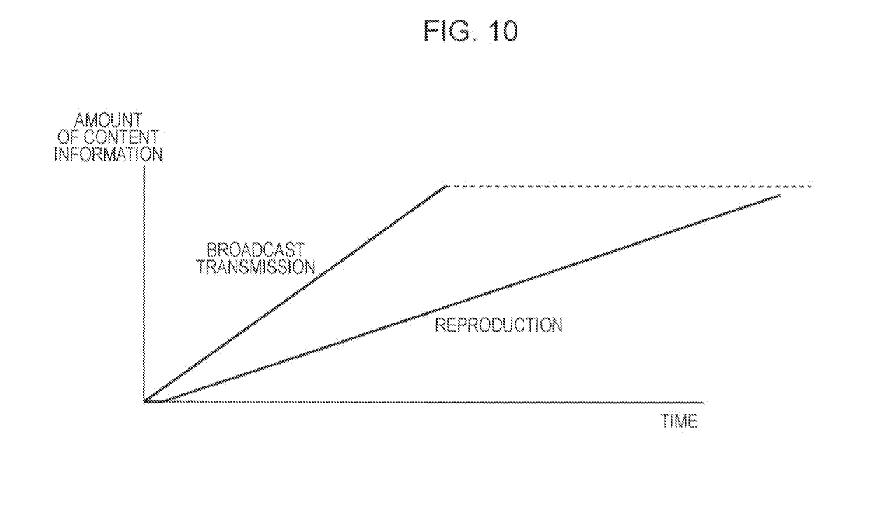

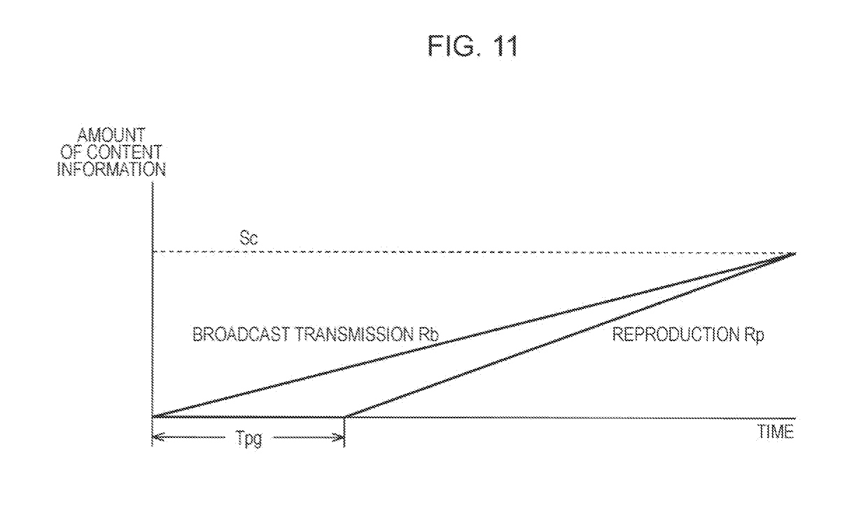

FIG. 10 illustrates a progressive reproduction-startable time in the high-speed downloading.

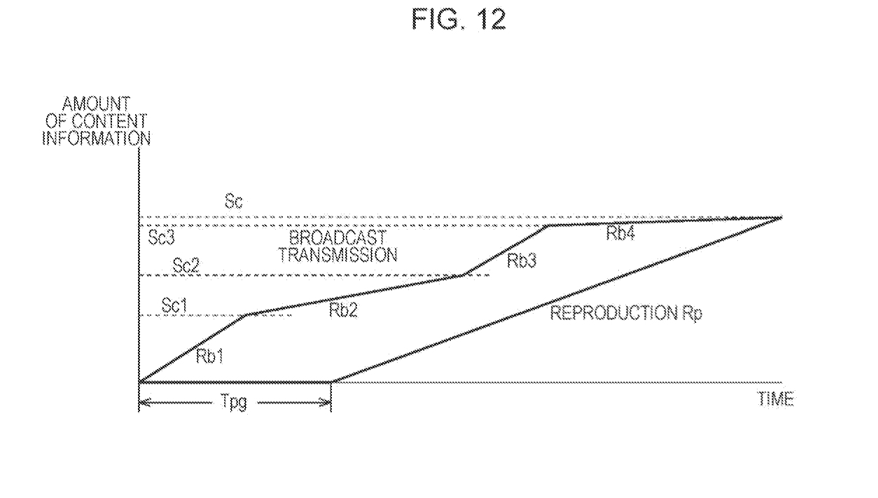

FIG. 11 illustrates a progressive reproduction-startable time in the low-speed downloading at a fixed broadcast transmission rate.

FIG. 12 illustrates a progressive reproduction-startable time in the low-speed downloading at a variable broadcast transmission rate.

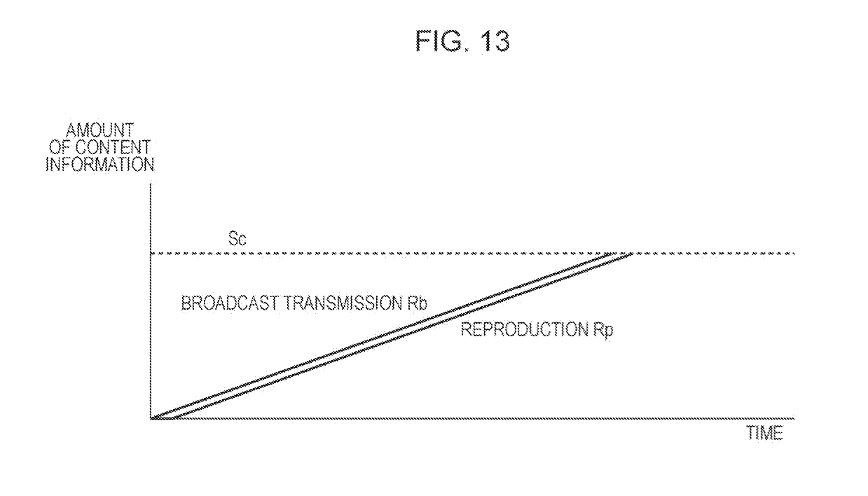

In FIGS. 10 to 12, the time is plotted on the horizontal axis, while the amount of content information is plotted on the vertical axis. The line BROADCAST TRANSMISSION indicates a transitional amount of downloaded DL content 31. The line REPRODUCTION indicates a transitional amount of reproduced DL content 31. The description in this paragraph also applies to FIG. 13.

As long as the line BROADCAST TRANSMISSION is located above the line REPRODUCTION, the downloaded amount exceeds the reproduced amount and the reproduction does not fail. On the contrary, although not shown, if the line BROADCAST TRANSMISSION substantially intersects the line REPRODUCTION, reproduction fails. This is because only the portion of the content equivalent to the downloaded amount, or the portion that has become reproducible (slightly less than the downloaded amount) is reproducible.

Accordingly, the reproduction-startable time should be set so that the line BROADCAST TRANSMISSION is located above the line REPRODUCTION until the DL content 31 is completely downloaded.

In high-speed downloading, as shown in FIG. 10, reproduction of DL content 31 does not fail even if its reproduction is started immediately after downloading of the content 31 is started. It is possible, therefore, to set the reproduction-startable time to any point in time after, even immediately after, downloading of DL content 31 is started (after the minimum cache time period has elapsed).

On the contrary, in low-speed downloading, reproduction of DL content 31 should be started with a certain time delay Tpg after downloading of DL content 31 is started as shown in FIGS. 11 and 12, to prevent reproduction failure. The time length Tpg is referred to below as a reproduction delay time Tpg. The reproduction-startable time should be set to a point in time with a reproduction delay time Tpg after downloading of DL content 31 is started.

The reproduction delay time Tpg can be calculated easily as follows.

For a fixed broadcast transmission rate, the reproduction delay time Tpg is calculated by the following equation (1), for example.

Tpg=Sc/Rb−Sc/Rp (1)

In equation (1), Sc represents the amount of information of the DL content 31 to be downloaded (for example, one download program in the present embodiment). Rb represents a fixed broadcast transmission rate. Rp represents a reproduction rate.

For a variable broadcast transmission rate, the reproduction delay time Tpg is calculated by the following equation (2), for example.

Tpg=Sc1/Rb1+(Sc2−Sc1)/Rb2+(Sc3−Sc2)/Rb3+(Sc−Sc3)/Rb4−Sc/Rp (2)

In equation (2), Sc represents the amount of information of the DL content 31 to be downloaded (for example, one download program in the present embodiment). Rp represents a reproduction rate. Rb1 represents the broadcast transmission rate from the download start time t0 to time t1. Sc1 represents the downloaded amount (amount of content information) at time t1. Rb2 represents the broadcast transmission rate from time t1 to time t2. Sc2 represents the downloaded amount at time t2. Rb3 represents the broadcast transmission rate from time t2 to time t3. Sc3 represents the downloaded amount at time t3.

The equation (2) calculates the reproduction delay time Tpg for the broadcast transmission rate that varies in three stages. If the broadcast transmission rate varies other than in three stages, the reproduction delay time Tpg can be calculated using an algorithm similar to the equation (2). In such a case, the reproduction delay time Tpg can be calculated by adding the term “(Scb−Sca)/Rbb” to the equation (2), where Rbb is the broadcast transmission rate from time ta to time tb, Sca is the downloaded amount at time ta, and Scb is the downloaded amount at time tb.

As described above, reproduction does not fail during high-speed downloading even if the reproduction operation is started immediately after the downloading is started.

On the other hand, for low-speed downloading, the reproduction operation should be started with a reproduction delay time Tpg after downloading is started, to prevent a reproduction failure halfway through. The reproduction delay time Tpg can be calculated at the receiving side if the broadcast transmission rate is fixed, but is difficult to calculate at the receiving side if the broadcast transmission rate is variable.

The operator of the broadcast station 11 or the like can easily calculate the reproduction delay time Tpg. The operator of the broadcast station 11 or the like may prepare and provide in advance the reproduction delay time Tpg to the receiving side. Then, the receiving side can easily start the reproduction operation with the reproduction delay time Tpg after the downloading is started. The reproduction delay time Tpg may be provided to the receiving side in any way. In the present embodiment, for example, information indicating the reproduction delay time Tpg is contained in the metadata 62 as will be described with reference to FIG. 16 and following figures.

The low-speed and high-speed broadcast downloading operations have been described in connection with progressive reproduction.

### [Equal-Speed Downloading]

It is further expected that a file is synchronously transmitted at the same rate as the reproduction rate for progressive reproduction in broadcast downloading. Such a broadcast downloading operation at the broadcast transmission rate equal to the reproduction rate will be referred to below as equal-speed downloading.

FIG. 13 illustrates a progressive reproduction-startable time in equal-speed downloading.

In equal-speed downloading, the reproduction of DL content 31 does not fail even if its reproduction is started immediately after its downloading is started, as shown in FIG. 13. The reproduction start time may be set to any point in time after the downloading of DL content 31 is started (after the minimum cache time period has elapsed).

If equal-speed downloading is adopted, the broadcast station 11, for example, can broadcast the DL content 31 as a live content for both purposes of real-time viewing and post-download viewing.

If equal-speed downloading is adopted for real-time viewing, an apparatus with no storage may be employed at the receiving side. A storage-unequipped version of the receiver 21 in FIG. 1 is referred to below as a receiver without storage 21B, in distinction from the receiver with storage 21A.

By adopting the equal-speed downloading, the broadcast station 11, for example, can broadcast live the DL content 31 as a proprietary content. Live delivery in a proprietary format may be prohibited by law in common streaming broadcasting.

The equal-speed downloading, if adopted, also enables proprietary CAS (conditional access system) broadcasting and Copy Never broadcasting. In common streaming broadcasting, the CAS system is difficult to achieve because the scheme system is limited, while in the broadcast downloading the proprietary CAS can be achieved easily. Although the Copy Never mode is customarily not used in common streaming broadcasting, the broadcast downloading is carried out spontaneously (as a result) in the Copy Never mode.

The equal-speed downloading will now be described in detail.

### [Sending and Receiving Flows for Equal-Speed Downloading]

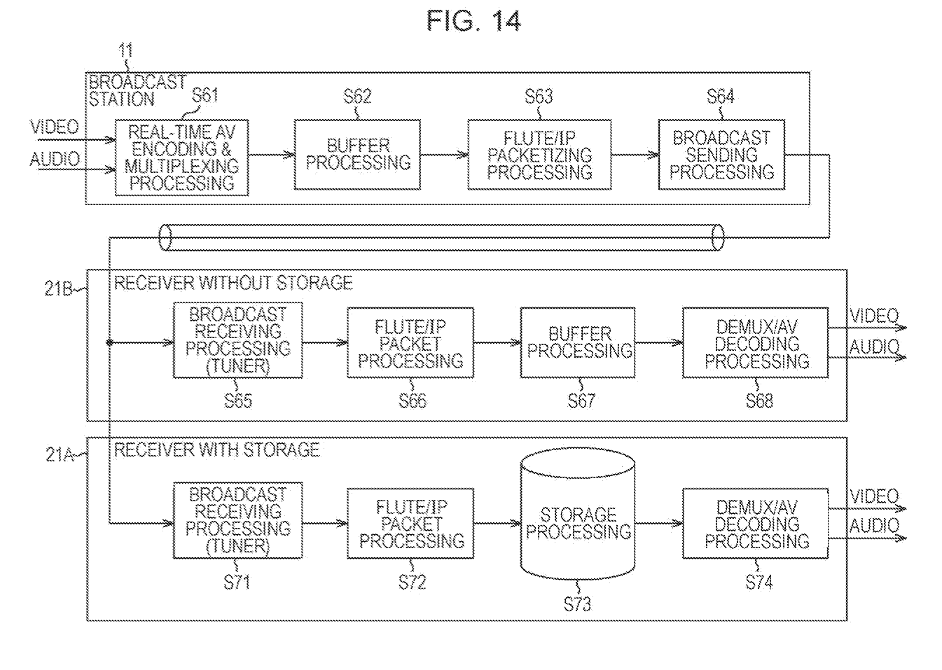

FIG. 14 illustrates the sending and receiving flows for equal-speed download broadcasting.

When video and audio signals forming the DL content 31 are supplied, the broadcast station 11 performs real-time AV encoding/multiplexing processing in step S61. The real-time AV encoding/multiplexing processing is basically similar to that shown in FIG. 2, except that it is intended for real-time broadcasting.

In step S62, the broadcast station 11 performs buffer processing. The buffer processing refers to a process of buffering a necessary amount of data obtained from the real-time AV encoding/multiplexing processing in step S61 and sequentially supplying the data to the next processing step.

For real-time broadcasting, steps S61 and S62 are employed in the example in FIG. 14. If a download program is created in advance, steps S11 and S12 in FIG. 2 may be adopted instead of the steps S61 and S62 in FIG. 14 even for equal-speed downloading.

The processing steps S63 and S64 are basically similar to the processing steps S13 and S14 in FIG. 2, so description thereof will be omitted here.

The receiving flow at the receiver with storage 21A for equal-speed downloading is basically the same as that shown in FIG. 2 for low-speed downloading or the like. The processing steps S71 to S74 at the receiver with storage 21A are basically similar to the processing steps S15 to S18 in FIG. 2, so description thereof will be omitted here.

The receiving flow at the receiver without storage 21B for equal-speed downloading includes processing steps S65 to S68.

The processing steps S65, S66, and S68 among the steps S65 to S68 are basically similar to the processing steps S71, S72, and S74 at the receiver with storage 21A, so description thereof will be omitted here.

Of the processing steps S65 to S68, only the processing in step S67 is different from the processing in step S73 at the receiver with storage 21A. In the receiver without storage 21B, buffer processing is performed in step S67, instead of the storage processing in step S73. The buffer processing enables real-time viewing.

### [Exemplary Configuration of Receiver Without Storage 21B]

FIG. 15 shows an exemplary configuration of the receiver without storage 21B.

In FIG. 15, the elements corresponding to those in FIG. 3 are denoted by the corresponding reference characters and description thereof will be omitted as appropriate.

In the example in FIG. 15, the receiver without storage 21B has a buffer 81, instead of the storage 44 provided in the receiver with storage 21A in the example in FIG. 3. The remaining configuration of the receiver without storage 21B is similar to the configuration of the receiver with storage 21A.

In the buffer processing in step S67 in FIG. 14, the buffer 81 buffers the data sequentially supplied from the DL processor 43 and sequentially supplies the data to the file demux unit 45.

### [Metadata According to an Embodiment of the Invention]

As described above, the low-speed download mode, high-speed download mode, and equal-speed download mode may be adopted for the download broadcasting according to an embodiment of the present embodiment.

In the present embodiment, for example, the metadata 62 about the delivery of content by download broadcasting further contains embedded information as described below.

Download-rate state information is embedded in the metadata 62 according to the present embodiment.

The download-rate state information refers to the information that discriminates among the following four download broadcasting modes. These modes will be referred to below as rate attributes.

The first rate attribute is “low-speed DL”. The “low-speed DL” is the low-speed downloading described above. The low-speed downloading will now be formally defined. The low-speed downloading is the mode in which the amount of information of the content file (DL content 31) being downloaded that has been downloaded over any time length since its downloading was started may be less than the amount of information of the content that has been reproduced over the same time length since its reproduction was started.

The second rate attribute is “high-speed DL”. The “high-speed DL” is the high-speed downloading described above. The high-speed downloading will now be formally defined. The high-speed downloading is the mode in which the amount of information of the content file being downloaded that has been downloaded over any time length since its downloading was started is more than the amount of information of the content that has been reproduced over the same time length since its reproduction was started.

The third rate attribute is “equal-speed DL”. The “equal-speed DL” is the equal-speed downloading described above in which the download rate (rate of broadcast downloading in FIG. 13, for example) and the reproduction rate are synchronized at the same rate.

The fourth rate attribute is “undefined”. The “undefined” is the mode in which the relationship between the download rate (rate of broadcast downloading in FIG. 13, for example) and the reproduction rate is unknown.

When information indicating the download-rate state “low-speed DL” is embedded in the metadata 62, information indicating a reproduction delay time Tpg is also embedded in the metadata 62.

Information indicating the download-rate state and information indicating reproduction delay time Tpg among the information pieces embedded in the metadata 62 are collectively referred to below as progressive DL information.

FIG. 16 shows an exemplary configuration of the metadata 62 according to an embodiment of the invention, in which the progressive DL information is embedded.

As shown in FIG. 16, the progressive DL information 92A is contained in the content delivery information 92 in the metadata 62.

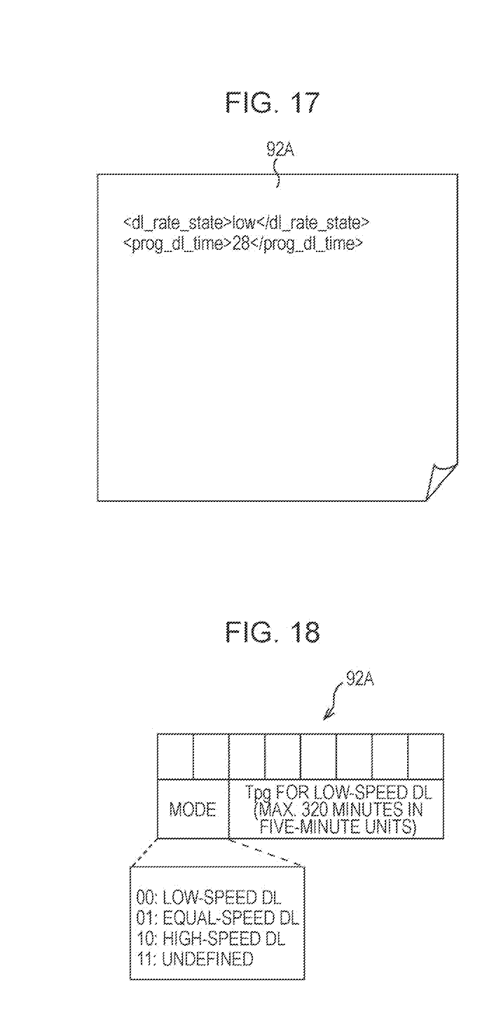

The progressive DL information 92A is not limited to any notation, as long as it can be embedded in the metadata 62. The notation shown in FIGS. 17 and 18 may be adopted, for example.

FIG. 17 shows an example of extensible markup language (XML) notation for the progressive DL information 92A.

The progressive DL information 92A in XML notation may be employed for non real-time (NRT) download broadcasting, for example, more specifically, for download broadcasting in Japan, for example. In this case, the progressive DL information 92A in XML notation can be embedded in the metadata 62 that is referred to as NRT-IT.

In FIG. 17, tags dl rate state indicate the download-rate state. A download-rate state is described between the tags. In the example in FIG. 17, “low” is described for rate attribute “low-speed DL”.

Tags plog_dl_time in the second line indicate the reproduction delay time Tpg. A reproduction delay time Tpg is described between the tags. The reproduction delay time Tpg is not limited to any unit of time, although “minutes” is adopted in the present embodiment. In the example in FIG. 17, “28” is described as the reproduction delay time Tpg.

Having acquired the progressive DL information 92A (metadata 62) in the example in FIG. 17, the receiving side learns that the rate attribute is “low-speed DL” and the reproduction delay time Tpg is 28 minutes. The receiving side can then reproduce the DL content 13 without reproduction failure halfway through if it starts its reproduction 28 minutes after its downloading is started.

FIG. 18 shows an example of binary notation of the progressive DL information 92A.

The progressive DL information 92A in binary notation can be adopted for download broadcasting to the United States, for example. In this case, the progressive DL information 92A in XML notation can be embedded in the metadata 62 in the private section format specified by the Moving Picture Experts Group (MPEG).

In the example in FIG. 18, the download-rate state is specified with the first two bits of one byte and the reproduction delay time Tpg is specified with the remaining six bits.

The above progressive DL information 92A is merely an example. The download-rate state information contained in the progressive DL information 92A is not limited to the information for discriminating among four rate attributes as in the above example, but may be any information as long as it indicates a state of the download rate with respect to the reproduction rate as its name suggests. The four rate attributes may not be all used, for example. Information for discriminating any one or more modes may be employed as the download-rate state information.

If the rate attribute is fixedly set to “low-speed DL”, for example, the progressive DL information 92A may contain information indicating the reproduction delay time Tpg alone and may not contain information indicating the download-rate state.

Having acquired the metadata 62 containing such progressive DL information 92A, the receiver 21 can then perform processing as described below, for example.

The receiver 21 can calculate the reproduction-startable time for each download program, from the delivery start time (information within the delivery schedule) and progressive DL information 92A in the metadata 62. The receiver 21 can then display, for ECG (local contents navigation), a program list showing the reproduction-startable time for each download program. The term “program list” is used here, instead of the term “list of accumulated contents” as in FIG. 8, because progressive reproduction is intended.

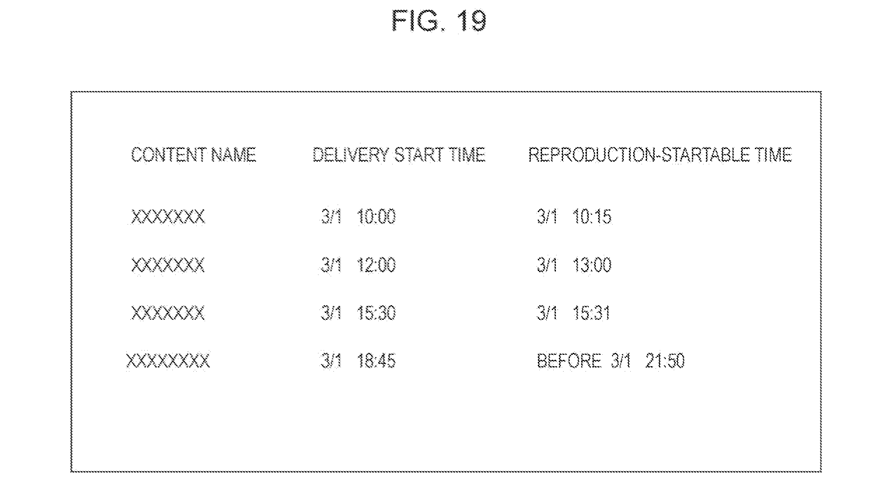

FIG. 19 shows an example of screen display of a program list for progressive reproduction.

In the program list in FIG. 19, REPRODUCTION-STARTABLE TIME is displayed, in addition to CONTENT NAME and DELIVERY START TIME. “Before 3/1 21:50” specified as the REPRODUCTION-STARTABLE TIME in the last line means that reproduction of the content in the last line can be started at an appropriate time before 21:50 on March 1st at which its delivery is completed. Such a display is provided if it is difficult to determine the reproduction-startable time because the receiver 21 fails to recognize the reproduction delay time Tpg due to the “undefined” download-rate state or for other reasons.

After the reproduction-startable time, the receiver 21 can display the reproducible contents for local navigation ECG and accept user operations for reproduction.

If the receiver without storage 21B recognizes “equal-speed DL” from the metadata 62, the receiver without storage 21B can display the download programs as real-time reproducible contents (programs), together with respective delivery start times. The receiver without storage 21B can then accept user operations for reproduction while the program is being delivered, then receive and cache the download program, and immediately synchronize and reproduce the program.

A series of exemplary processing steps (referred to below as metadata receiving processing) following the reception by the receiver 21 of the metadata 62 containing progressive DL information 92A will now be described.

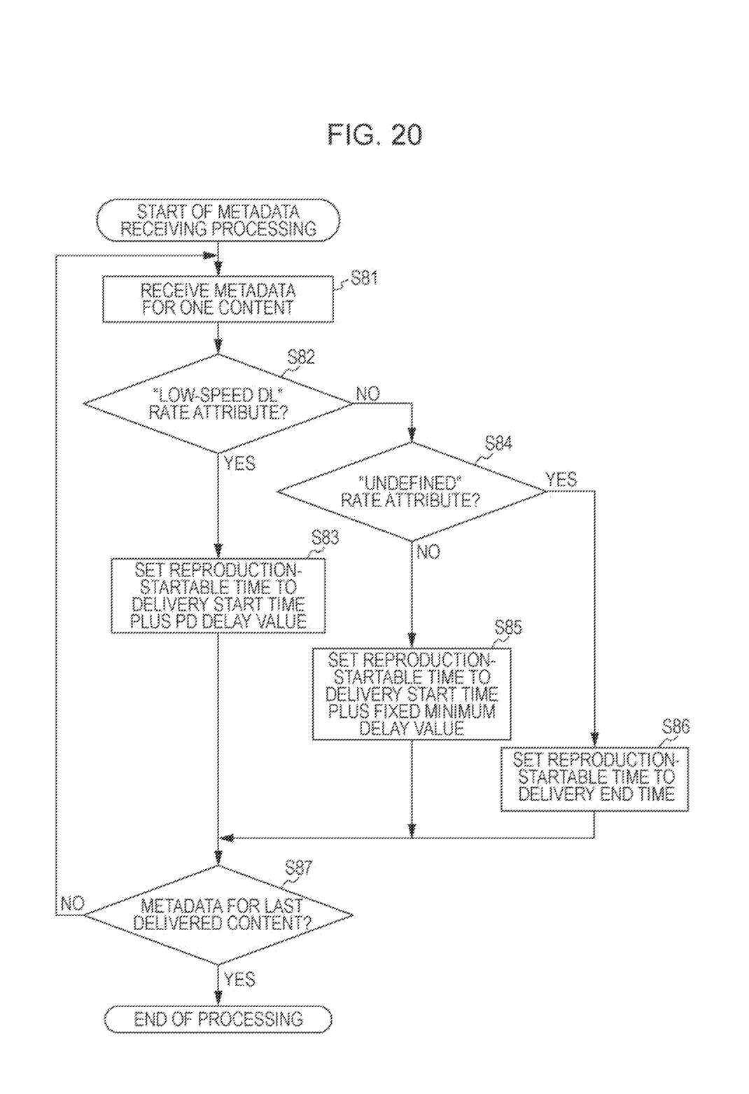

FIG. 20 is a flowchart illustrating an exemplary metadata receiving processing performed by the receiver with storage 21A.

In step S81, the receiver with storage 21A receives metadata 62 for one content.

One content corresponds to the DL content 31 contained in the single content file described above, for example, and more specifically, corresponds to one download program in the above example.

After the receiver with storage 21A analyzes the metadata 62 for one content, processing proceeds to step S82.

In step S82, the receiver with storage 21A determines whether or not the rate attribute is “low-speed DL”.

If the rate attribute is “low-speed DL”, YES results in step S82 and processing proceeds to step S83.

In step S83, the receiver with storage 21A sets the reproduction-startable time to the delivery start time plus a PD delay value. Then, processing proceeds to step S87. The processing in and after the step S87 will be described later.

The “PD delay value” in the processing in step S83 specifies a time length equal to or longer than the reproduction delay time Tpg indicated in the information contained in the progressive DL information 92A in the metadata 62.

If the rate attribute is other than the “low-speed DL”, NO results in step S82 and processing proceeds to step S84.

In step S84, the receiver with storage 21A determines whether or not the rate attribute is “undefined”.

If the rate attribute is “high-speed DL” or “equal-speed DL”, instead of “low-speed DL” or “undefined”, NO results in step S84 and processing proceeds to step S85.

In step S85, the receiver with storage 21A sets the reproduction-startable time to the delivery start time plus a fixed minimum delay value. Then, processing proceeds to step S87. The processing in and after step S87 will be described later.

The “fixed minimum delay value” in step S85 is a time length that is previously set, which is equal to or longer than the minimum cache time period.

If the rate attribute is “undefined”, YES results in step S84 and processing proceeds to step S86.

In step S86, the receiver with storage 21A sets the reproduction-startable time to the delivery end time.

After the reproduction-startable time is thus set in step S83, S85, or S86, processing proceeds to step S87.

In step S87, the receiver with storage 21A determines whether or not the metadata 62 is for the last delivered content.

If the metadata 62 is not for the last delivered content, there remains one or more contents for which the reproduction-startable time has not been set, so NO results in step S87 and processing is repeated from step S81. Processing is repeatedly looped between steps S81 and S87 until the reproduction-startable times for all the contents are set using respective delivered metadata 62.

Once the reproduction-startable times have been set for all the contents associated with all the delivered metadata 62, YES results in step S87 and the metadata receiving processing by the receiver with storage 21A is completed.

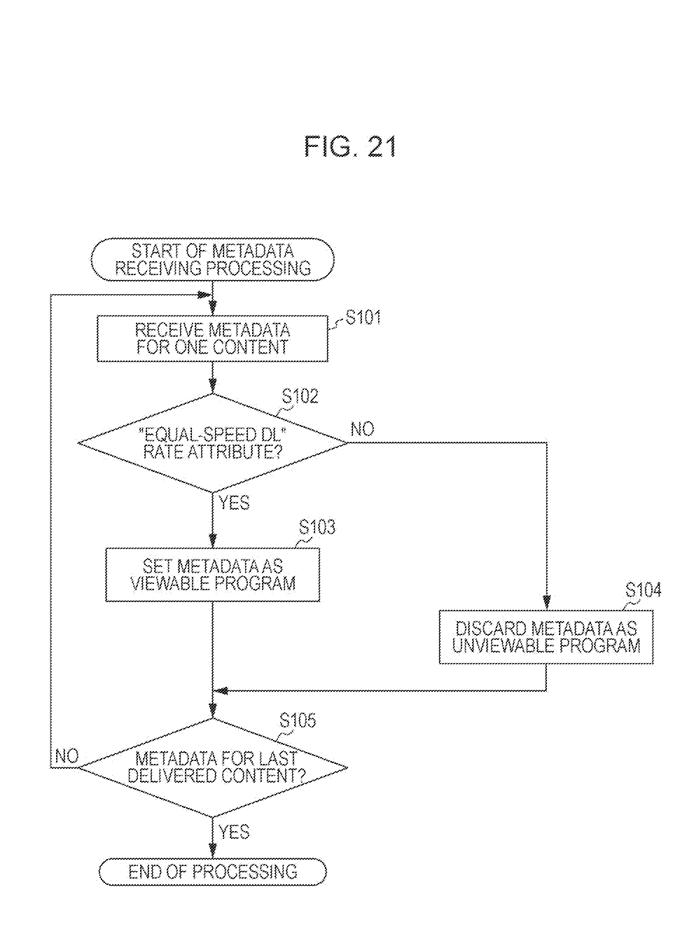

Referring now to FIG. 21, an example of metadata receiving processing performed by the receiver without storage 21B will be described.

FIG. 21 is a flowchart illustrating an example of metadata receiving processing performed by the receiver without storage 21B.

In step S101, the receiver without storage 21B receives metadata 62 for one content.

Once the receiver without storage 21B has analyzed the metadata 62 for one content, processing proceeds to step S102.

In step S102, the receiver without storage 21B determines whether or not the rate attribute is “equal-speed DL”.

If the rate attribute is “equal-speed DL”, YES results in step S102 and processing proceeds to step S103.

In step S103, the receiver without storage 21B sets as a viewable program the content (download program) associated with the metadata 62 received in the processing in step S101. Then, processing proceeds to step S105. The processing in and after the step S105 will be described later.

If the rate attribute is other than the “equal-speed DL”, NO results in step S102 and processing proceeds to step S104.

In step S104, the receiver without storage 21B determines the content (download program) associated with the metadata 62 received in the processing in step S101 to be an unviewable program and discards the metadata 62 for this content.

After the content is determined viewable or not in the processing in step S103 or S104, processing proceeds to step S105.

In step S105, the receiver without storage 21B determines whether or not the metadata 62 is for the last delivered content.

If the metadata 62 is not for the last delivered content, there remains one or more contents that have yet to be determined viewable or not, so NO results in step S105 and processing is repeated from step S101. More specifically, processing is repeatedly looped between steps S101 and S105 until all the contents are determined viewable or not.

Once all the contents associated with all the delivered metadata 62 are determined viewable or not, YES results in step S105 and the metadata receiving processing by the receiver without storage 21B is completed.

The sender of the metadata 62 is not limited to the broadcast station 11 as in the above example, but may be any apparatus other than the broadcast station 11.

### [Application of an Embodiment of the Invention to a Program]

The processing steps described above may be carried out by hardware or by software.

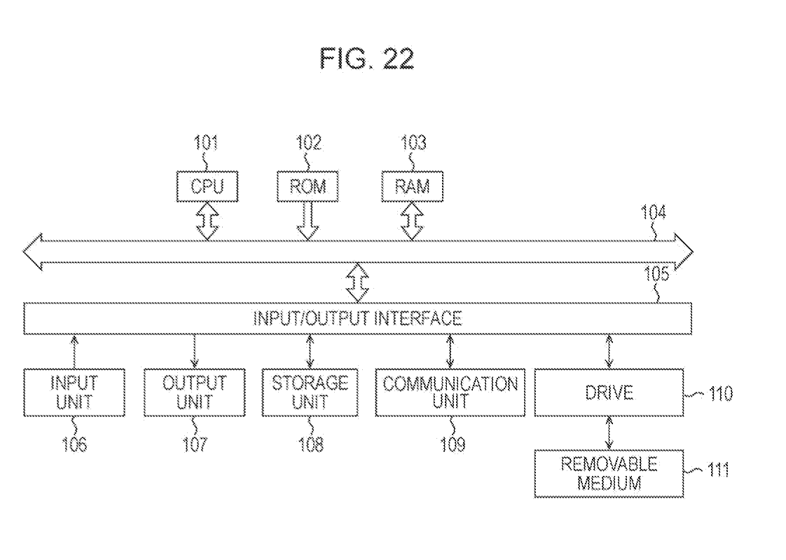

A personal computer as shown in FIG. 22, for example, may be employed at least as a part of the broadcast station 11 or receiver 21 described above.

In FIG. 22, a central processing unit (CPU) 101 carries out various types of processing according to the programs recorded in a read only memory (ROM) 102. The CPU 101 also carries out various types of processing according to the programs loaded into a random access memory (RAM) 103 from a storage unit 108. The RAM 103 also stores, as appropriate, data used by the CPU 101 to perform the various types of processing.

The CPU 101, ROM 102, and RAM 103 are mutually connected via a bus 104. An input/output interface 105 is also connected to the bus 104.

An input unit 106 including a keyboard and a mouse and an output unit 107 including a display are connected to the input/output interface 105. A storage unit 108 including a hard disk and a communication unit 109 including a modem and a terminal adapter are also connected to the input/output interface 105. The communication unit 109 controls communications with other devices (not shown) via the Internet and other networks.

A drive 110 is also connected, if necessary, to the input/output interface 105. A removable medium 111 such as a magnetic disk, optical disk, magneto-optical disk, or semiconductor memory is mounted as appropriate in the drive 110. Computer programs read out of the removable medium 111 are installed, if necessary, into the storage unit 108.

If a series of processing steps are to be carried out by software, the programs forming part of the software are installed from a network or a recording medium into a computer incorporated in a dedicated hardware or into a general-purpose personal computer that can perform various functions once various programs are installed.

As shown in FIG. 22, the recording medium containing such programs may be not only a removable medium (packaged medium) 111, such as a magnetic disk (including a floppy disk), optical disk (including a compact disk-read only memory (CD-ROM), digital versatile disk (DVD)), magneto-optical disk (including a mini-disk (MD)), or semiconductor memory, which are distributed, separately from the device body, to the user to provide programs, but also a hard disk mounted in the storage unit 108 and the ROM 102 having programs recorded therein, which are provided to the user as incorporated in the device body.

In this specification, the steps of describing the programs to be recorded in the recording medium includes not only the processing steps that are performed in the chronological order, but also the processing steps that may not be performed in the chronological order, but performed individually or in parallel.

In this specification, the term “system” refers to an entire equipment including a plurality of devices and processing units.

The present application contains subject matter related to that disclosed in Japanese Priority Patent Application JP 2009-061152 filed in the Japan Patent Office on Mar. 13, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
broadcasting means for broadcasting a content at a predetermined transmission rate to at least a receiver downloading the content; and
generating means for generating metadata for the content, the metadata including download-rate state information indicating a state of the predetermined transmission rate with respect to a reproduction rate at the receiver;
wherein the broadcasting means further broadcasts the metadata generated by the generating means.

2. The information processing device according to claim 1, wherein the metadata further contains information indicating a delay time before the receiver can start progressive reproduction of the content being downloaded after downloading of the content is started.

3. The information processing device according to claim 1, wherein the download-rate state information includes information indicating whether or not a mode in which the broadcasting means broadcasts the content at the predetermined transmission rate is an equal-speed download mode in which the predetermined transmission rate is synchronized with the reproduction rate at a same rate.

4. The information processing device according to claim 3,
wherein the download-rate state information further includes information indicating that the mode is one of
a low-speed download mode in which an amount of information of the content being downloaded that is downloaded over any time length since downloading of the content is started is in some cases less than an amount of information of the content that is reproduced over the time length since reproduction of the content is started,
a high-speed download mode in which an amount of information of the content being downloaded that is downloaded over any time length since downloading of the content is started is more than an amount of information of the content that is reproduced over the time length since reproduction of the content is started,
the equal-speed download mode, and
an undefined mode in which a relationship between the predetermined transmission rate and the reproduction rate is unknown.

5. An information processing method performed by an information processing device for broadcasting a content at a predetermined transmission rate to at least a receiver downloading the content, the method comprising the steps of:
generating metadata for the content, the metadata containing download-rate state information indicating a state of the predetermined transmission rate with respect to a reproduction rate at the receiver; and
broadcasting the generated metadata.

6. A program for causing a computer to perform a control process, the computer controlling a broadcasting apparatus for broadcasting a content at a predetermined transmission rate to at least a receiver downloading the content, the control process comprising the steps of:
generating metadata containing download-rate state information indicating a state of the transmission rate with respect to a reproduction rate at the receiver; and
broadcasting the generated metadata from the broadcasting apparatus.

7. An information processing device comprising:
receiving means for receiving a download content when the content is broadcast at a predetermined transmission rate from a broadcasting apparatus, and metadata for the content when the metadata is broadcast from the broadcasting apparatus or sent from an external device, the metadata containing download-rate state information indicating a state of the predetermined transmission rate with respect to a reproduction rate; and
reproduction control means for controlling, according to the metadata received by the receiving means, progressive reproduction of the content at the reproduction rate while the content is being received by the receiving means.

8. The information processing device according to claim 7,
wherein the metadata further contains information indicating a delay time before the progressive reproduction can be started after downloading of the content is started; and
wherein the reproduction control means starts the progressive reproduction at an optional time when the delay time elapses after the receiving means starts receiving the content.

9. The information processing device according to claim 7,
wherein the download-rate state information includes information indicating whether or not a mode in which the broadcasting apparatus broadcasts the content at the predetermined transmission rate is an equal-speed download mode in which the broadcasting apparatus synchronously broadcasts the content at the predetermined transmission rate equal to the reproduction rate; and
wherein the reproduction control means determines a point in time at which the progressive reproduction can be started, on the basis of the download-rate state information contained in the metadata received by the receiving means.

10. The information processing device according to claim 9,
wherein the download-rate state information further includes information indicating that the mode is one of
a low-speed download mode in which an amount of information of the content being downloaded that is downloaded over any time length since downloading of the content is started is in some cases less than an amount of information of the content that is reproduced over the time length since reproduction of the content is started,
a high-speed download mode in which an amount of information of the content being downloaded that is downloaded over any time length since downloading of the content is started is more than an amount of information of the content that is reproduced over the time length since reproduction of the content is started;
the equal-speed download mode, and
an undefined mode in which a relationship between the predetermined transmission rate and the reproduction rate is unknown.

11. The information processing device according to claim 9, wherein the reproduction control means further controls presentation to the user, together with presentation of the broadcast start time of the content, that the content is a real-time reproducible content, if the download-rate state information contained in the metadata received by the receiving means is information indicating the equal-speed downloading.

12. The information processing device according to claim 11, wherein the reproduction control means further controls, after controlling the presentation to the user, reception of an operation by the user for the progressive reproduction of the content after broadcasting of the content is started, and then caches the content received by the receiving means and controls reproduction of the content at the reproduction rate synchronous with the transmission rate when an instruction is given by the user to start reproduction.

13. The information processing device according to claim 7, the reproduction control means further controls presentation to the user of a reproduction-startable time at which the progressive reproduction can be started.

14. The information processing device according to claim 13, the reproduction control means further controls, after the reproduction-startable time, reception of a user operation for the progressive reproduction of the content.

15. An information processing method performed by a receiver for receiving a download content broadcast by a broadcasting apparatus at a predetermined transmission rate, the method comprising the steps of:
receiving metadata for the content when the metadata is broadcast by the broadcasting apparatus or sent from an external device, the metadata containing download-rate state information indicating a state of the predetermined transmission rate with respect to a reproduction rate; and
controlling, according to the received metadata, progressive reproduction for reproducing the content at the reproduction rate while the content is being received.

16. A program for causing a computer to perform a control process, the computer controlling a receiver for receiving a download content broadcast by a broadcasting apparatus at a predetermined transmission rate, the control process comprising the steps of:
receiving metadata for the content when the metadata is broadcast by the broadcasting apparatus or sent from an external device, the metadata containing download-rate state information indicating a state of the predetermined transmission rate with respect to a reproduction rate; and
controlling, according to the received metadata, progressive reproduction performed by the receiver for reproducing the content at the reproduction rate while the content is being received.

17. An information processing system comprising:
a first information processing device including
broadcasting means for broadcasting a content at a predetermined transmission rate to at least a receiver downloading the content, and
generating means for generating metadata for the content, the metadata containing download-rate state information indicating a state of the predetermined transmission rate with respect to a reproduction rate at the receiver,
wherein the broadcasting means further broadcasts the metadata generated by the generating means; and
a second information processing device including
receiving means for receiving the content and the metadata broadcast by the first information processing device, and
reproduction control means for controlling, according to the metadata received by the receiving means, progressive reproduction of the content at the reproduction rate while the content is being received by the receiving means.

18. An information processing device comprising:
a broadcasting apparatus broadcasting a content at a predetermined transmission rate to at least a receiver downloading the content; and
a generating unit generating metadata for the content, the metadata including download-rate state information indicating a state of the predetermined transmission rate with respect to a reproduction rate at the receiver;
wherein the broadcasting apparatus further broadcasts the metadata generated by the generating unit.

19. An information processing device comprising:
a receiver receiving a download content when the content is broadcast at a predetermined transmission rate from a broadcasting apparatus, and metadata for the content when the metadata is broadcast by the broadcasting apparatus or sent from an external device, the metadata containing download-rate state information indicating a state of the predetermined transmission rate with respect to a reproduction rate; and
a reproduction controller controlling, according to the metadata received by the receiver, progressive reproduction of the content at the reproduction rate while the content is being received by the receiver.
